(19) United States
(12) Patent Application Publication
(10) Pub. No.: US 2012/0325578 A1
(43) Pub. Date: Dec. 27, 2012

(54) MUFFLER ASSEMBLY AND METHOD OF MAKING

(75) Inventor: Fabrice S. J-M Giaume, Peillonnex (FR)

(73) Assignee: E I DU PONT DE NEMOURS AND COMPANY, Wilmington, DE (US)

(21) Appl. No.: 13/525,504

(22) Filed: Jun. 18, 2012

Related U.S. Application Data
(60) Provisional application No. 61/499,408, filed on Jun. 21, 2011.

(51) Int. Cl. F01N 13/18; F01N 1/08; B29C 45/14

(52) U.S. Cl. 181/282; 264/259; 181/212

(57) ABSTRACT

A muffler 1 comprises a polymeric housing 3 and a support bracket 16 for mounting the muffler on a vehicle. The support bracket 16 is made of a polymer composite material comprising a polymer and fibres and is integrally formed with the housing 3. The muffler is made by a method comprising providing a support bracket 16 made of a polymer composite material comprising a polymer and fibres, and forming a polymer housing 3 by contacting molten polymer with the support bracket 16 to bond the support bracket to the housing.

### CROSS-REFERENCE TO RELATED APPLICATIONS

This application claims the benefit of priority from U.S. Provisional Application No. 61/499,408, filed Jun. 21, 2011, which is incorporated herein by reference in its entirety.

### FIELD OF THE INVENTION

The present invention relates to the field of mufflers comprising a polymeric housing and to methods of making the same.

### BACKGROUND OF THE INVENTION

With the aim of replacing metal parts for weight saving and cost reduction while having comparable or superior mechanical performance, structures based on composite materials comprising a polymer matrix containing a fibrous material have been developed. With this growing interest, fiber reinforced plastic composite structures have been designed because of their excellent physical properties resulting from the combination of the fibrous material and the polymer matrix and are used in various end-use applications. Manufacturing techniques have been developed for improving the impregnation of the fibrous material with a polymer matrix to optimize the properties of the composite structure. In highly demanding applications, such as for example structural parts in automotive applications, composite materials are desired due to a unique combination of lightweight, high strength and temperature resistance.

Thermoplastic composite materials are made using a fibrous material, such as non-woven structures, textiles, fibrous battings and combinations thereof, the fibrous material being impregnated with a polymer resin composition (“thermoplastic composite materials”). There are various ways of making thermoplastic composite materials, including lamination, pre-impregnation and powder impregnation. In the lamination method, layers of fibrous material and layers of polymer film are alternately stacked, to form a stacked structure. This structure is subjected to heat and pressure to result in impregnation of the fibrous material with the polymer. The result in this case is a sheet that is substantially consolidated, i.e. it has very little void content. Such thermoplastic composite materials are typically referred to as laminates.

In the pre-impregnation method, the fibrous material has molten polymer applied to it, for example by dipping, extrusion of a molten film, or by spraying. The result in this case is a less consolidated structure, in which the fibrous material is partially impregnated with polymer.

In the powder impregnation method, layers of fibrous material are constructed with layers of finely powdered solid polymer. The structure is then subjected to heat and pressure, resulting in impregnation of the fibrous material with the polymer. In this case the result is a sheet that is substantially consolidated, i.e. with very little void content.

It is known from US 2009 0014236 to provide a muffler made of long fiber reinforced thermoplastic polymer. The muffler has first and second outer shells with edges which are brought into contact to form a housing shaped to fit within a space under a vehicle body. The muffler has an entry opening at one end to allow exhaust from an internal combustion engine to enter the interior of the housing, and an exit opening at the other end. Each opening is defined by a circular flange for receiving a respective entry bushing and exit bushing, through which bushings the exhaust pipe extends. Each shell is also molded with an internal rib for holding a baffle inside the housing.

### SUMMARY OF THE INVENTION

In one aspect, the present invention provides a muffler assembly, said assembly comprising a polymeric housing and a support bracket for mounting the muffler to a vehicle, the support bracket being made of a polymer composite material comprising a polymer and fibres and being integrally formed with the housing.

In another aspect, the invention provides a method of making a muffler, comprising: providing a support bracket made of a polymer composite material comprising a polymer and fibres; and forming a polymer housing by contacting molten polymer with the support bracket to bond the support bracket to the housing.

### DETAILED DESCRIPTION OF THE INVENTION

Disclosed herein is a muffler assembly wherein the muffler assembly comprises a polymeric housing and a support bracket for mounting said muffler to a vehicle, wherein the support bracket is made of polymer composite material. The support bracket made of a polymer composite material comprising a polymer and fibers can provide the strength required to mount the muffler on a vehicle. The support bracket may provide the required rigidity and strength to support the overall weight of the muffler, whilst said support bracker being integrated with the housing.

The support bracket may be made of a thermoplastic composite material as described above. The support bracket may be made in various ways. It may be made by one of the methods described above for making thermoplastic composite materials: lamination, pre-impregnation, or powder impregnation.

The support bracket, which may be a preformed component, and the housing may be molded together so that the support bracket and the housing are integrally formed. The support bracket may be placed in a mold and polymer is injected into the mold with the support bracket to form the housing. When the polymer of the housing is injection molded, the support bracket will be in intimate contact with and adhered to by the molten polymer. The polymer used for the housing is preferably the same as that used for at least the surface of the support bracket, so that good adhesion between the polymer of the housing and the support bracket is achieved. The overall polymer composite material of the support bracket may however be different from the material of the housing. For example, the fibers in the material of the support bracket may be different from fibers in the material of the housing. They be different in composition, orientation, width, length and/or density. The fibers of the support bracket may be chosen to give low creep properties and/or high stiffness. The housing may be designed with a material chosen for different properties, for example a tough material to provide good impact resistance against stone impact. It is desirable to have good stone impact resistance to reduce the risks of breakage and hot gas escape.

The polymer used to form the housing of the muffler with which the support bracket is integrally formed may be a thermoplastic or a thermosetting polymer. The polymer may be reinforced with glass, carbon, natural or other fiber. The fibers may be short fibers, long fibers, or in textile form, woven or non-woven. Woven fibers are preferred.

The polymer used to form the support bracket may be a thermoplastic or thermosetting polymer, with thermoplastic being preferred for flexibility of design and manufacture. The polymer may be reinforced with glass, carbon, natural or other fiber. The fibers may be short fibers, long fibers, or in textile form, woven or non-woven.

By providing a support bracket and placing it in a mold, and then by injection or overmolding the housing, there is the opportunity to select the materials appropriately for the respective functions of the support bracket and the housing, whilst also achieving integral formation of, or bonding between, these components. In preferred embodiments, it is not necessary to provide a separate support bracket, e.g. of steel, to support the muffler.

The housing may comprise a lower shell and an upper shell. The material for the upper and lower shells may be different, taking account of the required properties for each shell. For example the lower shell may comprise a thermoplastic composite material as defined above, including long fibers, and the upper shell may comprise a standard injection molding material.

In embodiments having a lower shell and an upper shell, the support bracket may be integrally formed with the lower shell.

The muffler may be provided with an exhaust entry opening at one longitudinal end thereof and an exhaust exit opening at the other longitudinal end. The entry and exit openings may be in line with each other or they may be laterally offset with respect to each other.

The support bracket is preferably elongate. It may extend on an outer wall of the housing, for example a downwardly facing, lower outer wall. Substantially all of the housing may be located above the lowermost part of the support bracket.

A plurality of support brackets may be provided, spaced apart from each other, for example longitudinally spaced. In a preferred embodiment, two support brackets are provided.

The (or each) support bracket may have a mounting portion to be attached to a vehicle. The mounting portion preferably projects outwardly, e.g. laterally outwardly, from the housing. This can enable it to mount the muffler on the e.g. underside of a vehicle. The mounting portion may at least partly define a peg. A bush may be provided to form a socket to receive the peg, and the bush may be attachable to a vehicle. In a preferred embodiment, the muffler comprises at least one bush for mounting to a vehicle and engaged by the mounting portion.

In embodiments having a lower shell and an upper shell, the mounting portion may be provided in a region where the lower and upper shells are joined together. The mounting portion may form part e.g. half of a peg, and the other part e.g. half of the peg may be provided by the upper shell.

The (or each) support bracket may have an elongate hanger portion depending downwardly from the mounting portion. The hanger portion may thus support the weight of the muffler. Where the housing has a lower shell and an upper shell, the hanger portion may support the weight of both shells. Where more than one support bracket is provided, the hanger portions of the respective support brackets may jointly support the weight of the muffler. The (or each) hanger portion may be generally “U” shaped. The hanger portion may have a lower portion extending (e.g. laterally) across the floor of the housing (e.g. generally horizontally) and a pair of upwardly extending portions, one at each end of the lower portion. By being integrally formed with a lower wall of the housing, the hanger portion may impart strength and support thereto.

The (or each) support bracket may have a plurality, e.g. a pair, of mounting portions spaced apart from each other, e.g. laterally spaced relative to the muffler. One of said mounting portions may be located on each side of the muffler. The hanger portion may then extend between the mounting portions, for example across the width of the muffler. Where the hanger portion has a lower portion and a pair of upwardly extending portions, a respective mounting portion may be provided at the upper end of each upwardly extending portion.

The (or each) support bracket may have a channel for supporting a baffle in the housing. Such a baffle may be used to define separate chambers within the housing for acoustic damping purposes. Thus the support bracket may serve a dual purpose of supporting the muffler on the vehicle, and providing location and support to an internal baffle. The channel may for example have a “U”, “V” or “W” shaped cross section.

An insert may be located between the channel and the baffle. Such an insert may be useful to provide acoustic and/or thermal insulation between the housing and the baffle.

The housing may have a bottom portion which comprises a preformed sheet. The preformed sheet can assist stone impact resistance. During manufacture, such a sheet may be placed in a mold below the support bracket to form the bottom portion of the housing. The sheet may then be overmolded by material so as to be integrally formed with the housing. The sheet may be a laminated sheet. Other structures, such as honeycomb and rib structures, may be used as inserts which are overmolded so as to be integrated in the muffler, in order to improve stiffness and crash resistance.

Certain preferred embodiments of the invention will now be described by way of example and with reference to the accompanying drawings, in which:

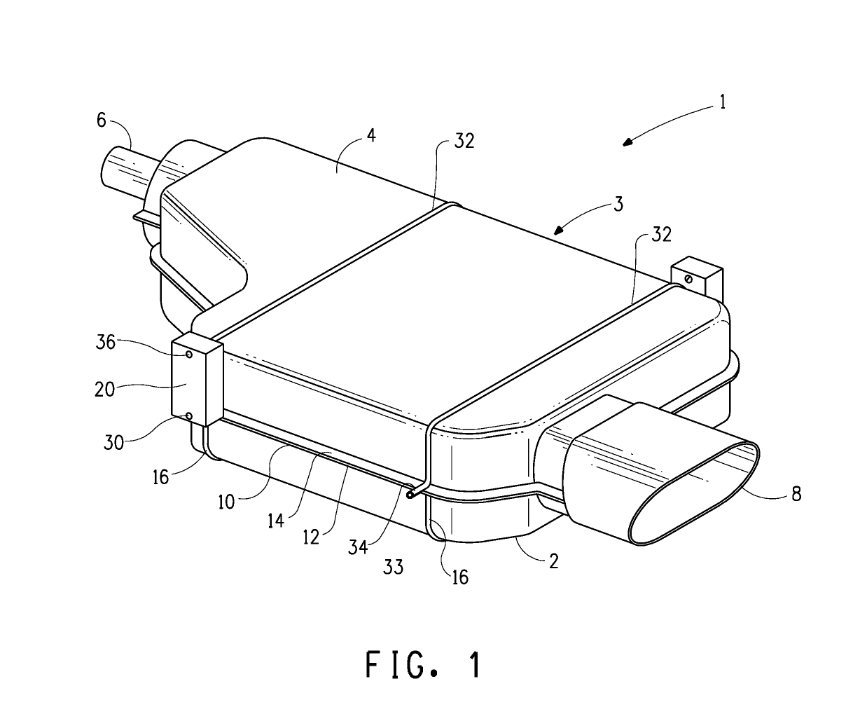

FIG. 1 is a perspective view of a muffler according to an embodiment of the invention;

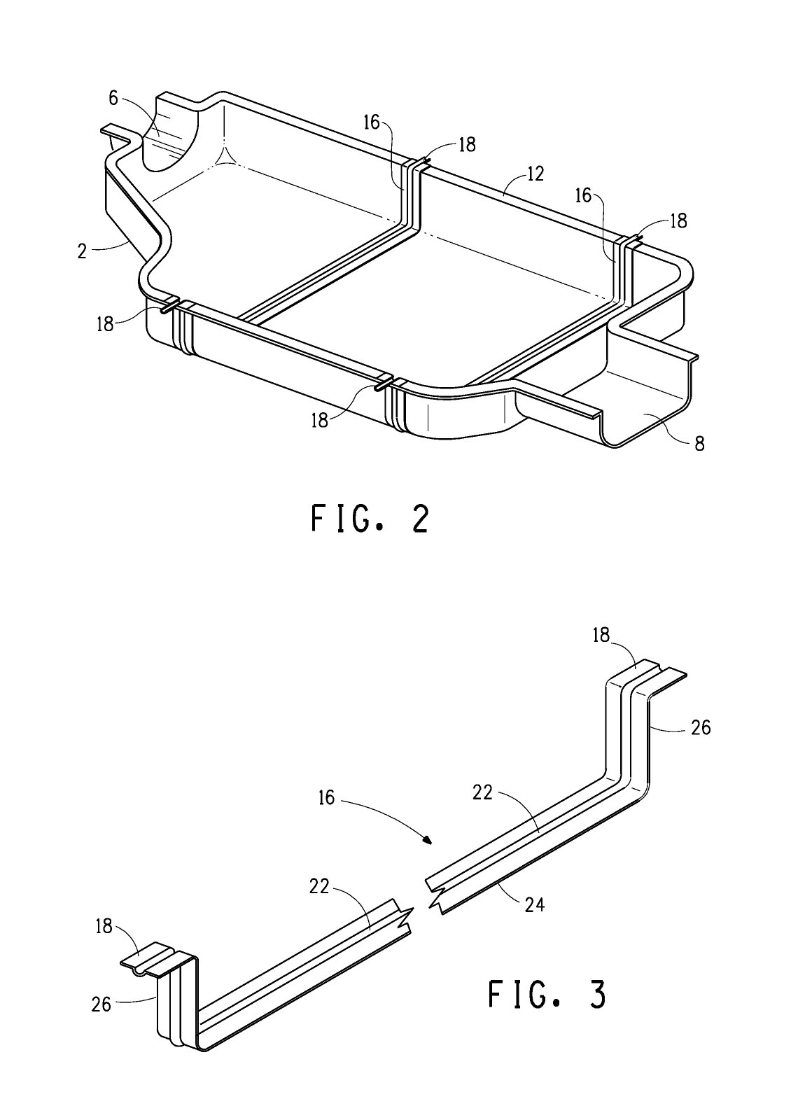

FIG. 2 is a perspective view of a lower shell of the muffler;

FIG. 3 is a perspective view of a preformed insert which is to form a support bracket of the muffler;

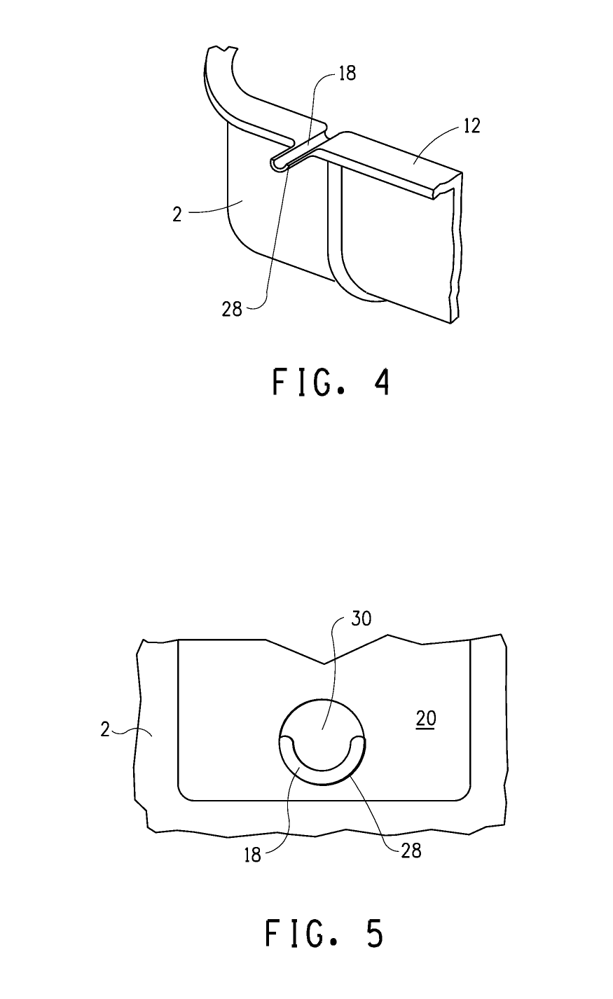

FIG. 4 is an enlarged perspective view of the lower shell showing a mounting portion of the support bracket;

FIG. 5 is a side elevation view of the mounting portion and a mount bush engaged therewith; and

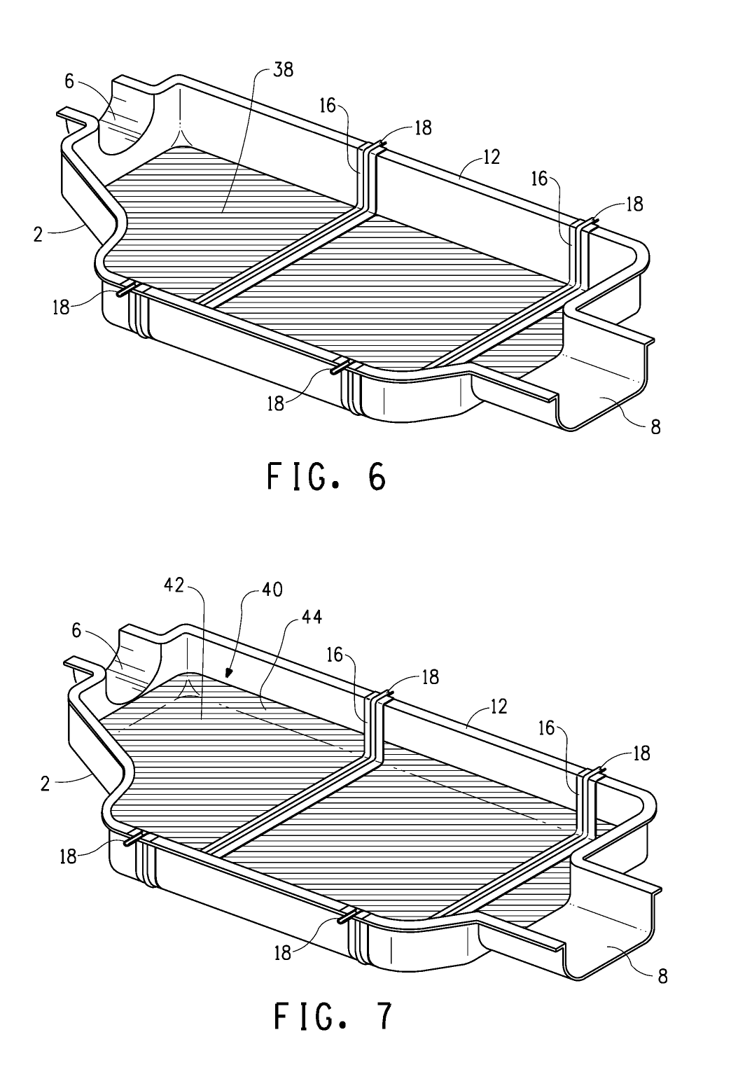

FIGS. 6, 7 and 8 are perspective views of the lower shell of respective mufflers with modifications.

Referring to FIG. 1, this shows a muffler 1 having a housing 3 comprising a lower shell 2 bonded to an upper shell 4. The muffler has an inlet end 6 into which exhaust gases from an internal combustion engine would be fed, and an exit end 8 from which the exhaust gases would emerge to atmosphere. The lower shell 2 is made of a polymer composite material comprising a polymer and long fibers, and the upper shell 4 is made of a thermo formable polymer. The shells are bonded by being welded together along a split line 10, where each shell has a respective peripherally extending flange 12 (of the lower shell 2) and 14 (of the upper shell 4).

The lower shell 2 is provided with a pair of laterally extending support brackets 16 which are longitudinally spaced from each other. Each support bracket has at each of its two lateral ends a respective mounting portion 18 (see FIG. 2), to which a mount bush 20 is attached. FIG. 1 shows only two mount bushes 20, but in practice four such mount bushes would be provided, one mounted to each of the four support bracket mounting portions. The upper shell 4 is formed with a pair of laterally extending ribs 32, the ribs 32 being longitudinally spaced from each other and positioned so as to be directly above the support brackets 16. Each rib 32 has at each end a part circular mounting portion 34.

FIG. 2 shows a perspective view of the lower shell 2 from above, revealing certain internal details. Each support bracket 16 has a cross-sectional profile including a channel 22 (see FIG. 3). This shape serves to improve the stiffness of the support member 16 and also provides a support for an acoustic baffle (not shown). Such acoustic baffles are known as such and form a wall dividing the interior of the muffler into separate chambers.

In this embodiment at least, the support bracket is made of a polymer reinforced with long fibers, e.g. glass fibers. The material will be chosen to provide a low creep property and high stiffness.

The support bracket 16 is shown in isolation in FIG. 3. Thus this Figure shows the support bracket as preformed ready to be inserted in a mold in which the lower shell will be molded, thereby ensuring that the support bracket and the lower shell 2 of the housing 3 will be integrally formed, or integrated together. The support bracket 16 consists of a laterally extending portion 24 which extends across the lower shell 2, a pair of upwardly extending portions 26 each at a respective end of the laterally extending portion 24, and the mounting portions 18 at the respective upper ends of the upwardly extending portions 26. The support bracket carries the weight of the muffler, acting as a hanger, and transfers that weight to the mounting portions 18 at its opposite ends.

FIGS. 4 and 5 show further details concerning the manner in which the muffler is to be mounted on a vehicle. As can be seen in FIG. 4 the mounting portion 18 has a part-circular, generally downwardly facing outer surface 28. This is inserted into a hole 30 in the mount bush 20. When the lower shell 2 and the upper shell 4 are welded together the mounting portion 18 of the support bracket 16 engages with the mounting portion 34 of the rib 32 of the upper shell 4. Together, the mounting portion 18 of the support bracket 16 and the mounting portion 34 of the rib 32 form a peg 33 (see FIG. 1) which fits into the hole 30 provided in the mount bush 20.

The hole 30 is formed in a lower part of the mount bush 20. Another hole 36 is formed in an upper part of the mount bush 20, as seen in FIG. 1. This hole 36 may be bolted or otherwise connected to a vehicle. In one embodiment the mount bushes 20 are formed of rubber, but alternative materials may be used. Thus the weight of the muffler is supported by the support bracket 16, which transfers the weight to the mounting portions 18 at its opposite ends, where the weight is supported by the mount bushes 20 and transferred to the vehicle. In this manner the muffler is suspended from the vehicle and the support bracket acts as a hanger whilst being integrated with the housing of the muffler. A separate support bracket around the outside of the housing is not required, nor is the weight of the muffler supported by the exhaust pipe, as is known in some systems.

In the embodiment shown in FIG. 6, when the lower shell 2 of the muffler is molded, in addition to the two support brackets 16 being placed in the mold as preformed inserts, another insert is provided by a flat sheet 38 located beneath the support brackets. This flat sheet is then overmolded together with the support brackets 16. The flat sheet is provided to improve impact resistance, in particular resistance to the impact of stones. The flat sheet may be a laminated material.

In the embodiment of FIG. 7, an insert 40 in the lower shell 2 includes a flat portion 42 as well as side portions 44. In this arrangement, the sides of the muffler are given improved stone impact resistance, in addition to the bottom. The insert 40 may be a stamped sheet of laminate in order to provide the required three dimensional form. This form also serves to increase the overall stiffness of the lower shell 2.

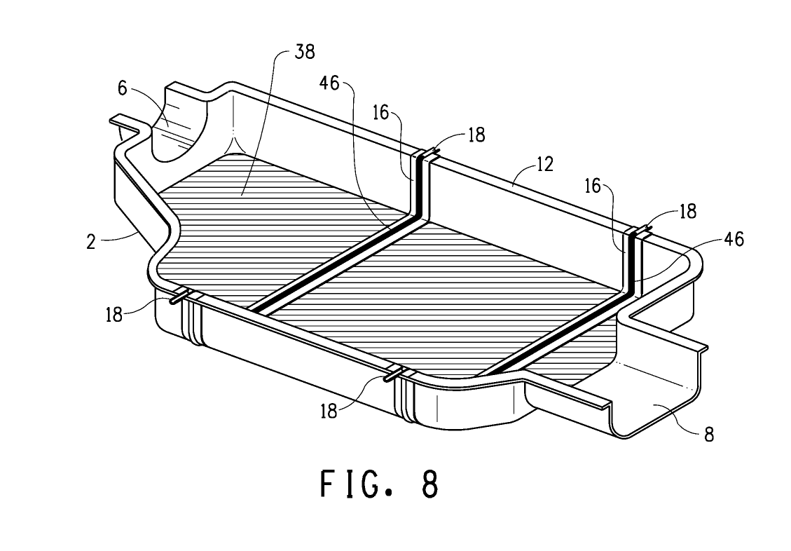

In the embodiment shown in FIG. 8, the channel 22 in each support bracket 16 is lined with a baffle support insert 46. The baffle support insert can improve the seal between the chambers separated by the baffle. The insert 46 may be integrally molded with the baffle itself.

The polymer used to form the lower shell 2 of the muffler may be a thermoplastic or a thermosetting polymer. The polymer may be reinforced with glass, carbon, natural or other fiber. The fibers may be short fibers, long fibers, or in textile form, woven or non-woven. Woven fibers are preferred.

By injection or overmolding a muffler housing onto a preformed insert which acts as a support bracket, the support bracket is integrated into the body of the muffler. This provides strength and creep resistance compared to a standard injection molded muffler and compared to a muffler made from fiber reinforced polymer where there is no specifically designed support bracket integrated into the muffler housing.

What is claimed is:

1. A muffler assembly, said assembly comprising a polymeric housing and a support bracket for mounting the muffler to a vehicle, the support bracket being made of a polymer composite material comprising a polymer and fibres and being integrally formed with the housing.

2. The muffler of claim 1, wherein the support bracket is elongate.

3. The muffler of claim 1, wherein the support bracket has a mounting portion to be attached to a vehicle.

4. The muffler of claim 3, wherein the mounting portion projects outwardly from the housing.

5. The muffler of 3, wherein the mounting portion at least partly defines a peg.

6. The muffler of claim 5, wherein the support bracket has an elongate hanger portion depending downwardly from the mounting portion.

7. The muffler of claim 6, wherein the hanger portion extends across a lower surface of said housing.

8. The muffler of claim 7, wherein the support bracket has a plurality of mounting portions spaced apart from each other.

9. The muffler of claim 1, wherein the housing comprises a lower shell and an upper shell, and wherein the support bracket is integrally formed with the lower shell.

10. The muffler of claim 1 wherein the support bracket has a channel for supporting a baffle in the housing.

11. The muffler of claim 1, wherein a bottom portion of the housing comprises a preformed sheet.

12. The muffler of claim 1, wherein the support bracket is a preformed component and the housing is moulded together with the support bracket so that the support bracket and the housing are integrally formed.

13. The muffler of claim 1, wherein the polymer composite material of the support bracket is different from the material of the housing.

14. A method of making a muffler, comprising:
providing a support bracket made of a polymer composite material comprising a polymer and fibres; and
forming a polymer housing by contacting molten polymer with the support bracket to bond the support bracket to the housing.

15. The method as claimed in claim 14, comprising placing the support bracket in a mould and injecting polymer to form the housing into the mould.
